(19) United States
(12) Patent Application Publication
(10) Pub. No.: US 2016/0121249 A1
(43) Pub. Date: May 5, 2016

(54) BLOCK PRODUCTS INCORPORATING SMALL PARTICLE THERMOPLASTIC BINDERS AND METHODS OF MAKING SAME

(71) Applicant: ARKEMA INC., King of Prussia, PA (US)

(72) Inventor: Evan E. KOSLOW, Dallas, TX (US)

(73) Assignee: Arkema Inc., King of Prussia, PA (US)

(21) Appl. No.: 14/889,506

(22) PCT Filed: May 8, 2014
(86) PCT No.: PCT/US2014/037223

§ 371 Date: Nov. 6, 2015

Related U.S. Application Data
(60) Provisional application No. 61/821,980, filed on May 10, 2013.

(51) Int. Cl. B01D 39/20

(52) U.S. Cl. CPC B01D 39/2062

(57) ABSTRACT

A block product comprising a thermoplastic binder having an average particle size of less than 20 micrometers fused with active particles to form a generally coherent porous structure. In some cases, the average particle size of the binder is less than 12 micrometers. In some cases, the active particles are activated carbon particles. In some cases, the block product may include one or more of poly(vinylidene difluoride) binders, nylon-11, and nylon-12 or other odd-numbered polyamides having such small particle size.

### FIELD

The embodiments herein relate generally to block products, and more particularly to block products, such as activated carbon blocks, that are formed using small particle thermoplastic binders, and methods of forming the same.

### INTRODUCTION

Carbon block is a filtration medium that may have various commercial uses, including in the production of consumer and industrial water filters. Some carbon block products are composites that include activated carbon, at least one binder, and optionally other additives that are compressed and fused into a generally coherent porous structure.

In some cases, a carbon block filter product may be shaped as a right circular cylinder with a hollow bore therethrough (which may also be circular) so as to form a tube. In some applications, the flow of water or other fluids may be directed generally in a radial direction through the wall of this tube (either outwardly or inwardly). Passage of the fluid through this carbon block filter product, which is porous, may result in a reduction of one or more of particulate and chemical contaminants in the fluid.

Carbon blocks may be formed by converting mixtures of activated carbon powder and powdered polyethylene plastic binder into a solid porous monolithic structure by compression transfer molding, extrusion, or some other process. In such cases the mixture of activated carbon and powdered polyethylene plastic binder is compressed, heated, and then cooled to cause the polyethylene particles to fuse the mixture into an unsaturated carbon monolith structure. In such unsaturated structures, the binder does not completely fill or saturate the pores of the carbon block, and thus open pores remain.

These open pores of the carbon block facilitate the flow of a fluid through the carbon block. In this manner, the carbon block can filter the flow of fluid passing through it by intercepting particulate contaminants within the fluid. This may occur by direct interception of particular contaminants by the carbon block or by adsorption of the particular contaminants onto the surface of the carbon block.

The carbon block may also intercept chemical contaminants, for example by participating in chemical reactions on the surface of the activated carbon of the carbon block, by adsorption, or by hosting ion-exchange interactions with charged or polar sites on the activated carbon.

Traditionally, carbon block structures have been produced using polyolefinic polymer binders such as polyethylene. For example, some carbon block structures have been produced using ultra high molecular weight polyethylene (“UHMWPE”) binders, or low-density polyethylene (“LDPE”) binders. Other carbon block structures have been produced using poly(ethylene vinyl acetate) (“(p(EVA))”) binders. However, carbon block structures formed using these polymer binders tend to suffer from poor operating temperatures, poor chemical resistance, and low strength, and may be relatively expensive.

### BRIEF DESCRIPTION OF THE DRAWINGS

The drawings included herewith are for illustrating various examples of systems, apparatus and methods of the present disclosure and are not intended to limit the scope of what is taught in any way. In the drawings:

FIG. 1 is a schematic view of a carbon block filter according to one embodiment; and

FIG. 2 is a flowchart of a method for forming carbon block according to one embodiment.

### DESCRIPTION OF VARIOUS EMBODIMENTS

One or more of the embodiments herein may be directed to a carbon block that includes a polymer binder that is selected to impart one or more of improved physical and improved chemical properties to the carbon block structure. Such embodiments may also allow the use of the carbon block in industrial applications where solvents, elevated temperatures, and elevated pressures might be encountered.

Some embodiments may include a polymer that can be directly synthesized as a polymeric powder without the need for physical grinding and attrition (which can be exceedingly expensive). Such a polymeric powder may be much smaller than typically possible through conventional grinding (and even by cryogenic grinding).

In some embodiments, the polymeric powder is a thermoplastic having at least a moderate melt flow index, and an average particle size of less than 20 micrometers, less than 15 micrometers, less than 12 micrometers, less than 10 micrometers, or even approximately 5 micrometers (or less). Average particle size is measured on a polymer suspension using a Mastersizer® 3000 (from Malvern) laser particle size analyzer. Preferred thermoplastic polymers include, but are not limited to, poly(vinylidene difluoride) binders, nylon-11, and nylon-12 or other odd-numbered polyamides having such small particle size

In accordance with some embodiments, a carbon block may include a poly(vinylidene difluoride) (“PVDF”) binder that supports a network of activated carbon particles, such as a Kynar® fluoropolymer resin. As used herein, the terms poly(vinylidene difluoride) binder and PVDF binder shall be understood to mean a binder comprising one or more of poly(vinylidene difluoride), polymers related to poly(vinylidene difluoride), and copolymers containing at least 70 weight percent of vinylidene difluoride units.

Unlike polyethylene-based binders, PVDF binders are generally resistant to a broad spectrum of solvents, and can be safely used at temperatures above 120 degrees Centigrade. Moreover, PVDF binders can be obtained with very small average particles sizes, including particles sizes of less than 20 micrometers. In some cases, PVDF binders may be available at sizes of less than 10 micrometers, and in some cases even at sizes of around 5 micrometers (or smaller).

In some applications (e.g., high-pressure filtration), a carbon block should have a high compression strength to withstand the forces generated during filtration.

To satisfy this requirement, traditional carbon block products normally include a significant concentration of polymeric binders. For example, carbon blocks made using an LDPE binder typically include greater than 16% binder (by weight), whereas carbon blocks made using UHMWPE binders typically include greater than 25% binder (by weight).

In contrast, the inventor has unexpectedly discovered that carbon blocks made using certain PVDF binders can have high compression strengths with only 3 to 14% binder (by weight), preferably 12% or less, preferably 10% or less, and preferably 5 to 8%.

Accordingly, significantly less PVDF binder may be used (by weight) as compared to traditional techniques (in some cases 2-5 times less binder). This reduced quantity of binder may offset at least some of the higher costs normally associated with PVDF binders (for example as compared to the cost of polyethylene binders).

Moreover, the volumetric amount of PVDF binder required to make a high compression strength carbon block may be even smaller (as compared to the required volume of polyethylene binder), since the absolute density of PVDF (approximately 1.78 grams per cubic centimeter) is nearly twice that of LDPE (approximately 0.91 to 0.94 grams per cubic centimeter) and UWMWPE (0.93 to 0.97 grams per cubic centimeter). Therefore, a high compression strength carbon block may require 4 to 10 times less (by volume) of PVDF binder as compared to a polyethylene binder.

The relative volume of binder in a carbon block contributes to a number of performance characteristics, including porosity, permeability, carbon surface fouling, and quantity of activated carbon inside the carbon block. Each of these characteristics generally improves with a reduction in the relative volume of binder. Accordingly, carbon blocks made using the small required volume of PVDF binder may display at least one of:
(i) pores that are substantially open and free of binder resulting in superior porosity and permeability;
(ii) reduced fouling of the carbon surface by molten polymer during processing; and (iii) reduced displacement of activated carbon by the binder, resulting in an increased quantity of activated carbon within the carbon block.

Correspondingly, carbon blocks made using PVDF binder may have superior filtering performance over carbon blocks made using conventional (e.g., polyethylene) binders. The improved porosity and permeability may provide more passages for fluid to pass through the carbon block. More passages, combined with reduced fouling of the carbon surfaces and an increased quantity of activated carbon, may result in more sites for the interception, adsorption and chemical reaction with contaminants in the fluid passing through the carbon block.

The performance of carbon blocks made using PVDF binder may also allow for a smaller (e.g., thinner) carbon block to perform equally well as compared to a larger conventional carbon block made using a conventional binder. Such a smaller carbon block may provide additional cost savings, as it may require less activated carbon to produce. A smaller carbon block may also be more desirable because it may weigh less and may occupy less space when installed.

In some embodiments, with a suitable grade of PVDF binder, a carbon block product can be produced using high-speed extrusion machines, or by using compression molding techniques. Making a carbon block generally involves mixing a binder (in a powdered form) with activated carbon powder. The two powders are normally thoroughly mixed to produce a substantially homogenous mixture. The mixed powders are then fused together, for example using compression transfer molding or extrusion.

Generally, mixtures of powders with smaller average particle sizes can produce mixtures that are more homogenous as compared to mixtures with larger average particle sizes. For example, a thoroughly mixed mixture of large particles will normally be less homogenous than a similarly mixed mixture of fine powders. That is, a small sized sample of a mixture of large particles is more likely to contain a composition that differs significantly from the composition of the mixture as a whole.

Furthermore, as the relative volume of one powder in a thoroughly mixed mixture decreases, the homogeneity of that mixture may also decrease, unless the average particle size of that one powder is reduced. To illustrate this point, consider the homogeneity of three exemplary mixtures labeled A, B and C:

TABLE 1
Homogeneity of Exemplary Mixtures

| | Powder 1 | No. of | Powder 2 | No. of |
|---|---|---|---|---|
| | Particle Size | Powder 1 | Particle Size | Powder 2 |
| Mixture | (mm³) | Particles | (mm³) | Particles |
| A | 1.0 | 1000 | 1.0 | 1000 |
| B | 1.0 | 2 | 1.0 | 1000 |
| C | 0.001 | 2000 | 1.0 | 1000 |

In each of mixtures A, B and C, the volume, average particle size and quantity of powder 2 particles remains constant. Compared to mixture A, mixture B contains 500 times less volume of powder 1 particles (because there are only two particles instead of 1000). Consequently, the homogeneity of a thoroughly mixed mixture B will be less than that of a thoroughly mixed mixture A. That is, a small sized sample of mixture B is much more likely to contain a composition that differs significantly from the composition of the mixture as a whole, as compared with mixture A.

In contrast, mixture C contains the same volume of powder 1 as in mixture B, but the particles are 1000 times smaller and therefore 1000 times greater in number. Consequently, the homogeneity of a thoroughly mixed mixture C will be much greater than a thoroughly mixed mixture B. That is, a small sized sample of mixture B is much more likely to contain a composition that differs significantly from the composition of the mixture as a whole, as compared with mixture C.

This example illustrates that the loss of homogeneity that results from decreasing the average volume of a powder in a mixture can be compensated for by decreasing the average particle size of that powder.

As discussed above, a carbon block containing a PVDF binder may comprise 4 to 10 times less binder by volume as compared to a conventional binder (e.g. a UHMWPE or LDPE binder). Accordingly, to encourage a homogeneous mixture, powdered PVDF binder may be provided with a smaller average particle size (i.e. a size that is 4 to 10 times smaller) as compared to the particle size of a conventional binder.

Conventional binders (e.g., a UHMWPE or LDPE binder) are often made into powders through grinding or attrition, resulting in relatively coarse powders. In contrast, the average particle diameter of powdered PVDF binders may be less than 20 micrometers, less than 10 micrometers, or even approximately 5 micrometers (or smaller).

Such small particle sizes may not be readily achievable through conventional techniques, such as grinding or attrition, or even cryogenic grinding. Therefore, in some cases, powdered PVDF binder may be directly synthesized without the need for physical grinding and attrition.

Through direct synthesis, powdered PVDF binder is routinely available in fine and ultra-fine powders. Directly synthesized powdered PVDF binder is also available as ultra-pure powder, usually substantially free of hazardous extractable contaminants.

Direct synthesis can be expensive and may contribute to the high cost of small-sized powdered PVDF binders. Fortunately, since according to the teachings herein carbon blocks can be made with very little PVDF binder, this higher cost may not be too problematic.

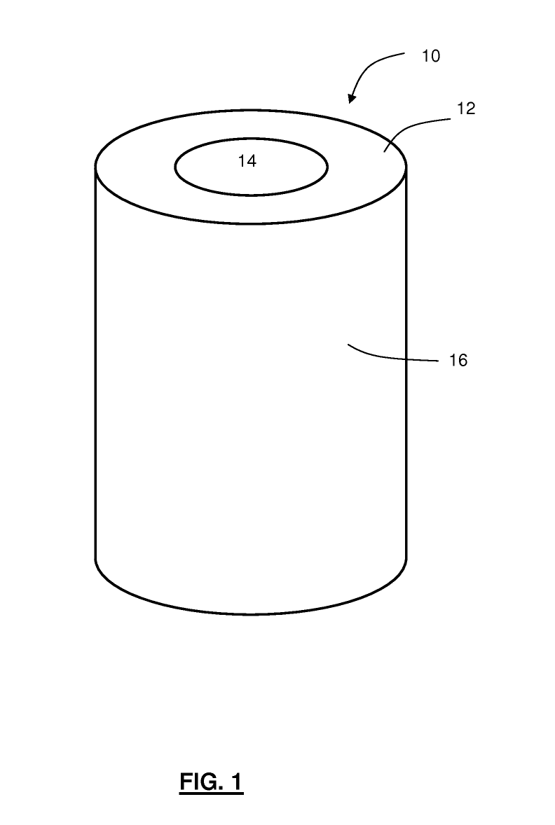

Turning now to FIG. 1, illustrated therein is a schematic view of a carbon block filter 10 according to one embodiment. In this embodiment, the carbon block filter 10 is shaped as a right circular cylinder 12 with a hollow bore 14 generally therethrough. In this embodiment, the hollow bore 14 is circular so that the cylinder forms a tube. It will be understood in some embodiments that the carbon block filter 12 may have other suitable shapes.

In some applications (for example in filtering applications), water or other fluids may be directed generally in a radial direction through the walls 16 of the cylinder 12 (either outwardly or inwardly). For example, in some embodiments a liquid can be directed outwardly from the bore 14 and through the walls 16. Passage of the fluid through the walls 16 of the carbon block filter 10 tends to result in a reduction of one or more of particulate and/or chemical contaminants in the fluid.

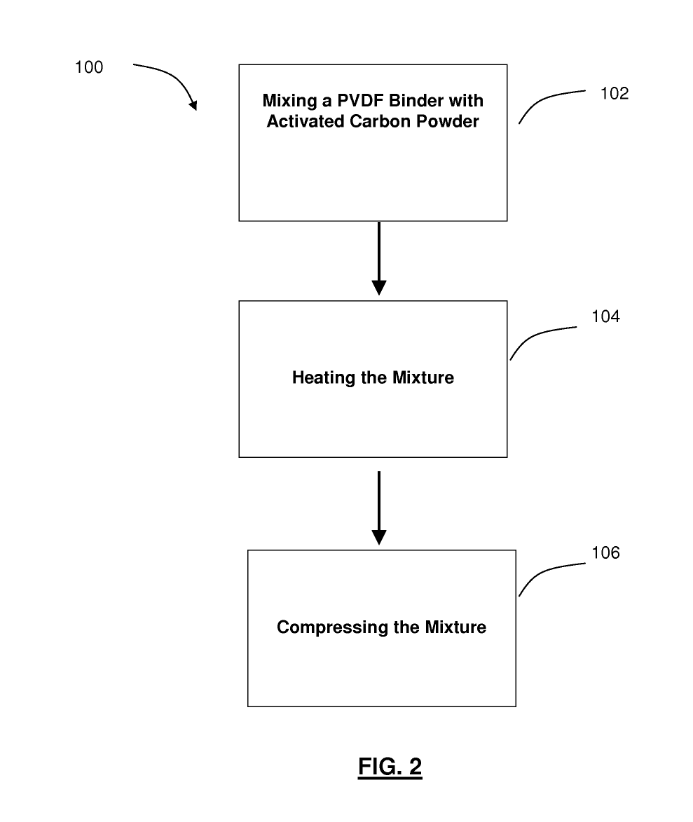

Turning now to FIG. 2, illustrated therein is a flowchart of a method 100 for forming carbon block according to one embodiment.

At step 102, poly(vinylidene difluoride) binder powder is mixed with an activated carbon powder. In some cases, the poly(vinylidene difluoride) binder powder may have an average particle size of less than 20 micrometers, less than 12 micrometers, or even about 5 micrometers.

At step 104 the mixture of binder and activated carbon powder is heated. For example, the mixture may be heated in an oven that is at or around 425 degrees F.

At step 106, the mixture of binder and activated carbon powder is then compressed. In some embodiments, the compression may be done after the mixture is at least partially heated or even fully heated. In some embodiments, the compression may be done at least partially concurrently with the heating.

In some embodiments, the compression may be performed by compression transfer molding the mixture. In some embodiments, the compression of the mixture may be performed by extruding the mixture.

### EXAMPLES

The following examples demonstrate methods of making a carbon block using a PVDF binder. The examples also illustrate that carbon blocks containing very low quantities of PVDF binder (by weight) can meet the compression strength requirements for high-pressure filtration applications. Other aspects and advantages may also be present.

### Example 1

### Transfer Compression Molding Trials with PVDF Binder

A series of mixtures of PVDF binder (Arkema Incorporated, King of Prussia, Pa., grade 741 PVDF) and activated carbon (80×325 mesh coconut-shell based activated carbon with a BET surface area of approximately 1200 square meters per gram) were made by intensive mixing of the two powders. The mixtures included 8%, 10%, 12% and 14% of PVDF binder by weight respectively. Each mixture was loaded into a suitable copper mold of 2.54″ inside diameter and placed into a preheated oven at 425 degrees Fahrenheit. After 30 minutes, the molds were removed from the oven and immediately (while still hot) subjected to compression of greater than 100 pounds per square inch pressure, and then allowed to cool. After cooling the samples were ejected from the mold.

The carbon blocks produced from each of the samples exhibited compression strengths above the requirement for high-pressure filtration applications. This indicates that high compression strength carbon blocks be made using as little as 8% PVDF binder by weight.

Under this experiment, it was also unexpectedly discovered that carbon blocks using PVDF binder had essentially little or no adhesion or friction to the walls of the molding die. There was little back pressure created by the movement of the powder against the extrusion die's surfaces, suggesting that this mixture of binder and activated carbon may be suitable for extrusion applications, particularly high speed.

In comparison, polyethylene-based carbon blocks (16% LDPE by weight, MI=6, Equistar Microthene grade 51000) manufactured using the same procedure in this example exhibited aggressive adhesion to the mold walls sufficient to make ejection of the carbon blocks quite difficult.

### Example 2

### Transfer Compression Molding Trials with Very Low PVDF Binder Content

A series of mixtures of PVDF binder (Arkema Incorporated, King of Prussia, Pa., PVDF grade 741) and activated carbon (80×325 mesh coconut-shell based activated carbon with a BET surface area of approximately 1200 square meters per gram) were made by intensive mixing of the two powders. The mixtures included 8%, 7%, 6% and 5% PVDF binder by weight respectively. Each mixture was loaded into a suitable copper mold of 2.54″ inside diameter and placed into a preheated oven at 425 degrees F. After 30 minutes, the molds were removed from the oven and immediately (while still hot) subjected to compression of greater than 100 pounds per square inch pressure, and then allowed to cool. After cooling the samples were ejected from the mold. All of the samples had good structural integrity even for those samples containing as little as 5% PVDF binder. However, samples containing smaller amounts of binder had surfaces that released particles when rubbed and were considered of lower commercial quality.

### Example 3

### Performance of Extruded PVDF Carbon Block Compared to Extruded LDPE Carbon Block

A series of carbon blocks were manufactured using KYNAR® resin (a PVDF binder) and compared to a standard commercial carbon block manufactured using LDPE. Carbon blocks were manufactured including 6%, 8%, and 10% KYNAR (by weight) and compared to a carbon block including 16% LDPE (by weight). The extrusion of the carbon blocks was accomplished with sufficient applied pressure to achieve a cohesive carbon block with a target mean flow pore size (MFP) of 3 to 4 micrometers. Pore sizes of 3 to 4 micrometers are typical in commodity-grade carbon block products with a nominal micron rating of 1 to 2 micrometers. Because of the low adhesion of PVDF to the extruder surfaces compared to LDPE, the PVDF-based mixture can be extruded at up to four times greater speed than a LDPE-based mixture within the same final carbon block geometry. This allows for greatly enhanced productivity during production.

Multi-point nitrogen-adsorption isotherms of carbon blocks containing 8% KYNAR, 10% KYNAR and 16% LDPE (by weight) were carried out to observe the impact of the binder on the surfaces of the carbon macropores and micropores. The samples were subjected to high vacuum at moderate temperatures prior to surface area analysis. Table 2 below summarizes the results of the nitrogen adsorption isotherm data.

TABLE 2
Results of Nitrogen Adsorption Data

| | | Total BET | | | |
|---|---|---|---|---|---|
| | | Surface | Pore | | |
| | Weight | Area | Volume | Micropore | Macropore |
| | (g) | (m²/g) | (cc/g) | Area (m²/g) | Area (m²/g) |
| 8% | 0.145 | 966.7 | 0.449 | 775 | 191 |
| KYNAR | | | | | |
| 10% | 0.150 | 893.2 | 0.424 | 722 | 170 |
| KYNAR | | | | | |
| 16% | 0.268 | 658.9 | 0.331 | 528 | 131 |
| LDPE | | | | | |

The results show that compared to the 16% LDPE carbon block, the 8% KYNAR carbon block had, per gram, 47% greater macropore surface area, and 46% greater micropore surface area for a combined 46.7% improvement in total BET surface area. Furthermore, the 8% KYNAR carbon block had 36% greater pore volume per gram compared to the 16% LDPE carbon block, which is consistent with the surface area results. The results for the 10% KYNAR carbon block fell between the results for the 8% KYNAR carbon block and the 16% LDPE carbon block.

As surface area is positively correlated to the adsorption rate and capacity. The results show that the 8% KYNAR carbon block exhibited the highest performance characteristics of the samples tested.

Flow porometry testing was carried out on carbon block samples containing 6% KYNAR, 8% KYNAR, 10% KYNAR, and 16% LDPE (by weight) to identify the mean flow pore size (MFP), the maximum pore size (bubble point) and the overall permeability. Generally, permeability measures the flow rate of a fluid through the carbon block, when the fluid is at a predetermined pressure. A higher permeability permits a higher flow rate of fluid to cross the carbon block with a reduced drop in pressure. The maximum pore size (bubble point) measured for the carbon block is indicative of the carbon block's uniformity. A larger maximum pore size indicates that at least one larger void exists in the carbon block which may permit unwanted particulate contamination to penetrate the structure. The results of the porometry testing is summarized in Table 3 below.

TABLE 3
Porometry Testing

| | | | Permeability |
|---|---|---|---|
| | MFP | Bubble Point | (lpm of air @ 10 |
| | (μm) | (μm) | psid) |
| 6% KYNAR | 3.24 | 20.64 | 15.7 |
| 8% KYNAR | 3.56 | 18.60 | 24.9 |
| 10% KYNAR | 3.81 | 18.99 | 19.2 |
| 16% LDPE | 3.09 | 22.91 | 19.1 |

The results show that the 8% KYNAR carbon block had the greatest permeability of the tested samples and 30% greater permeability than the 16% LDPE. Further, the 8% KYNAR carbon block had the lowest bubble point of the tested samples indicating good structural uniformity. These results demonstrate that the 8% KYNAR carbon had the best performance characteristics of the tested samples.

The results of the multi-point isotherms and the flow porometry testing show that the 8% KYNAR carbon block exhibited performance characteristics that are superior to the other tested carbon block samples, including the 16% LDPE carbon block. In some cases, an 8% KYNAR carbon block product can be reduced in size by 35-40% compared to a 16% LDPE carbon block product and exhibit comparable performance characteristics. Further, the difference in density between KYNAR and LDPE means that the 8% KYNAR carbon block had 72% less volume of binder than the 16% LDPE carbon block. Accordingly, using 8% KYNAR in a carbon block product may permit a smaller product, with less binder, that provides at least comparable performance at potentially a lower cost.

### Other Suitable Binders

In some embodiments, one of more other binders may be suitable for forming block products (e.g., carbon blocks) with active particles (e.g., activated carbon particles or other particles) supported by the binder in a generally coherent porous structure. Some such suitable binders may include thermoplastic powders having an average particle size of less than 20 micrometers, and more particularly having an average particle size of between about 12 micrometers and 1 micrometer. Suitable thermoplastic polymer powders may also have a sufficiently high melt flow index so as to ensure that the powder will melt and bond with the particles to form the porous structure.

In some cases, suitable binders may include small polyamide particles (e.g., particles of Nylon-11 or Nylon-12) with an average particle size of less than about 12 micrometers. It should be noted that PVDF and Nylon-11 binders might be particularly suitable for use as binders as both polymers are ferroelectric and highly polarized. Other odd-number polyamides such as Nylon-7 have similar properties. Because such polymers are unusually polarized, it is possible that they have a reduced tendency to wet carbon surfaces and cause fouling of the adsorbent's surfaces.

In some cases, other suitable thermoplastic polymer powders may be used to form carbon blocks or other block products.

1. A block product comprising a thermoplastic binder having an average particle size of less than 12 micrometers fused with active particles to form a generally coherent porous structure.

2. The block product of claim 1, wherein the average particle size of the binder is about 5 micrometers.

3. The block product of claim 1 wherein the active particles are activated carbon particles.

4. The block product of claim 1, wherein the thermoplastic binder is selected from the group consisting of:
a) poly(vinylidene difluoride) binders;
b) nylon-11;
c) nylon-12; and
d) other odd-numbered polyamides

5. A carbon block comprising a poly(vinylidene difluoride) binder fused with activated carbon.

6. The carbon block of claim 5 wherein the binder has an average particle size of less than 20 micrometers.

7. The carbon block of claim 5, wherein the poly(vinylidene difluoride) binder comprises between about 5 and 14 percent of the carbon block by weight.

8. The carbon block of claim 5, wherein the average particle size of the binder is less than 12 micrometers.

9. The carbon block of claim 5, wherein the average particle size of the binder is about 5 micrometers.

10. A method of making a carbon block comprising:
mixing a poly(vinylidene difluoride) binder powder with an activated carbon powder;
heating the mixture of binder and activated carbon powder;
compressing the mixture of binder and activated carbon powder.

11. The method of claim 10, wherein the poly(vinylidene difluoride) binder powder has an average particle size of less than 20 micrometers.

12. The method of claim 10, wherein the poly(vinylidene difluoride) binder powder has an average particle size of less than 12 micrometers.

13. The method of claim 10 wherein the compression of the mixture is performed by compression transfer molding the mixture.

14. The method of claim 10, wherein the compression of the mixture is performed by extruding the mixture.

15. A carbon block made by the method of claim 10.

16. A fluid filter comprising a carbon block according to claim 10.
